(19) United States
(12) Patent Application Publication
(10) Pub. No.: US 2013/0327173 A1
(43) Pub. Date: Dec. 12, 2013

(54) OPERATION DEVICE

(71) Applicant: Kabushiki Kaisha Tokai Rika Denki Seisakusho, Aichi (JP)

(72) Inventor: Masayoshi IWATA, Aichi (JP)

(21) Appl. No.: 13/905,780

(22) Filed: May 30, 2013

(30) Foreign Application Priority Data
Jun. 6, 2012 (JP) 2012-129138

(51) Int. Cl. F16H 59/10

(52) U.S. Cl. CPC F16H 59/105
USPC 74/473.12

(57) ABSTRACT

An operation device that controls an apparatus. The operation device includes an operation member that is movable to a plurality of positions. The operation device sends an electric signal to the apparatus in accordance with the position of the operation member. A tactile force application mechanism applies tactile force to the operation member when the operation member is moved. The tactile force application mechanism includes a tactile force detection unit that detects the tactile force applied to the operation member and outputs a tactile force detection signal. A position determination unit determines the position of the operation member based on the tactile force detection signal.

### CROSS-REFERENCE TO RELATED APPLICATIONS

This application is based upon and claims the benefit of priority from prior Japanese Patent Application No. 2012-129138, filed on Jun. 6, 2012, the entire contents of which are incorporated herein by reference.

### FIELD

The present invention relates to an operation device used to control an apparatus.

### BACKGROUND

A vehicle includes a shift lever device that shifts modes of a transmission. Japanese Patent 4373212 and Japanese Laid-Open Patent Publication Nos. 2002-254944 and 2007-253912 describe prior art examples of a shift lever device. Such a shift lever device may be provided with a momentary type shifting mechanism. When a driver moves a shift lever to a certain mode position and then releases the shift lever, the shift lever automatically returns to a home position. Nowadays, shift levers often employ shift-by-wire control. In such control, an electric signal indicating the detected position of the shift lever is sent to the transmission to shift the drive state of the transmission accordingly.

A shift lever device uses a sensor to detect the movement amount of a shift lever and determine the position of the shift lever based on the detection. Accordingly, the movement amount of the shift lever determines the shifting of modes of the transmission. However, the tactile force acting on the shift lever and perceived by the driver when the driver moves the shift lever may not be in complete synchronism with the mode shifting of the transmission. This makes it difficult for the driver to perceive whether or not the position of the shift lever has been switched. Such a problem is not unique to a shift lever device and may also occur in other devices.

### SUMMARY

One aspect of the present invention is an operation device that controls an apparatus. The operation device includes an operation member that is movable to a plurality of positions. The operation device sends an electric signal to the apparatus in accordance with the position of the operation member. A tactile force application mechanism applies tactile force to the operation member when the operation member is moved. The tactile force application mechanism includes a tactile force detection unit that detects the tactile force applied to the operation member and outputs a tactile force detection signal. A position determination unit determines the position of the operation member based on the tactile force detection signal.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing one embodiment of a shift lever device;

FIG. 2 is a schematic diagram illustrating the structure and operation of a tactile force application mechanism;

FIG. 3 is a schematic diagram showing a tactile force detection mechanism;

FIG. 4 is an electric diagram of the shift lever device; and

FIG. 5 is a graph showing how the tactile force of a shift lever and the inductance of a coil changes relative to the movement amount of the shift lever device.

### DESCRIPTION OF THE EMBODIMENTS

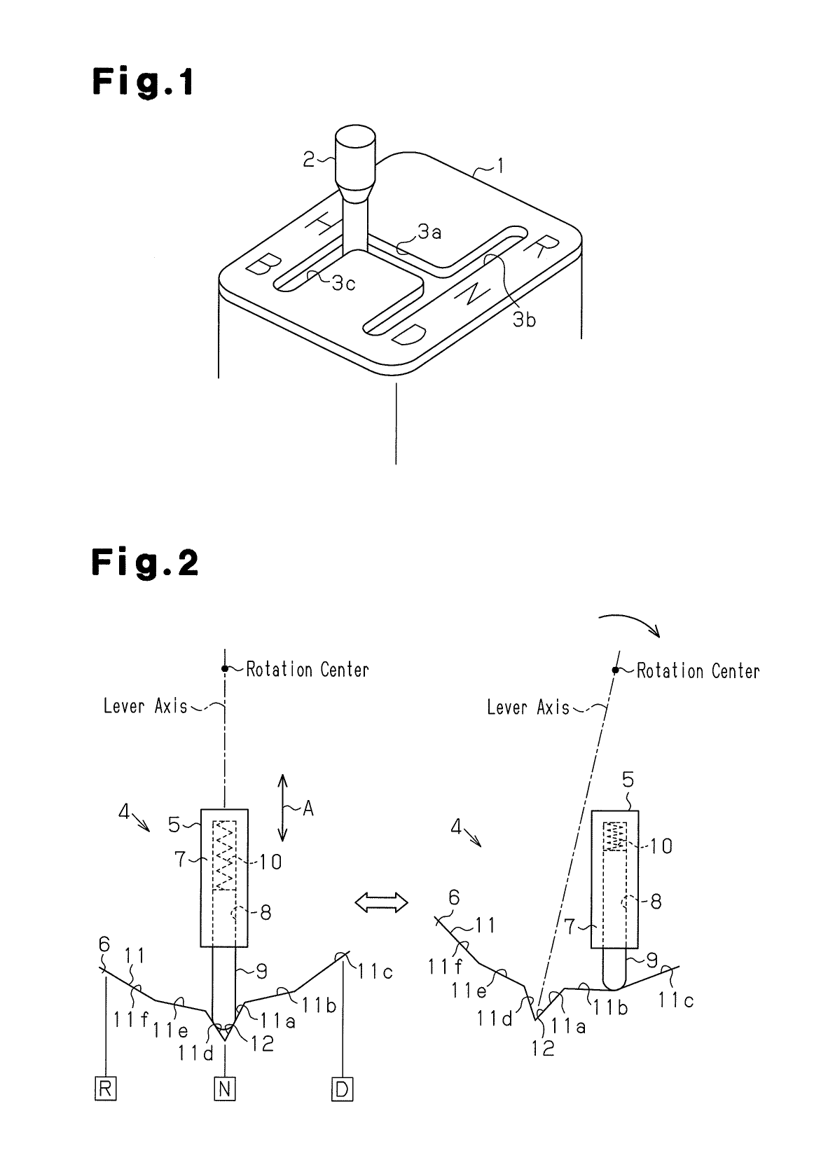

One embodiment of an operation device applied to a shift lever device will now be described with reference to FIGS. 1 to 5.

Referring to FIG. 1, a vehicle provided with an automatic transmission includes a shift lever device 1 used when shifting modes of the transmission. The shift lever device 1 includes a shift lever 2, which is pivotally movable. In the present embodiment, the shift lever device 1 employs shift-by-wire control in which the shift lever device 1 provides the transmission with an electric signal indicating the position of the shift lever 2 to shift the mode of the transmission accordingly. Further, the shift lever device 1 includes a momentary type shifting mechanism. In the momentary type, when an operator, or driver, moves the shift lever 2 from a home position to a certain mode position and then releases the shift lever 2, the shift lever 2 automatically returns to the home position. When the shift lever 2 is not operated, the shift lever 2 is held at the home position. The shift lever device 1 is one example of an operation device, and the shift lever 2 is one example of an operation member.

In the present embodiment, in addition to the home position, the mode positions of the shift lever 2 includes a neutral (N) position, a drive (D) position, a reverse (R) position, and a regenerative brake (B) position. The shift lever 2 is movable in gates 3a, 3b, and 3c. The gate 3a extends in a selection direction. The gates 3b and 3c each extend in a shift direction and are respectively located at a right side and a left side of the shift lever device 1 as viewed in FIG. 1. When the shift lever 2 is moved to the N position, the transmission is disengaged from the power train. The N position is located in the gate 3a at the opposite side of the home position. When the shift lever 2 is moved to the D position, the transmission drives the vehicle in a forward direction. The D position is located at the lower end of the gate 3b, as viewed in FIG. 1. When the shift lever 2 is moved to the R position, the transmission drives the vehicle in a rearward direction. The R position is located at the upper end of the gate 3b, as viewed in FIG. 1. When the shift lever 2 is moved to the B position, the transmission is in a regenerative brake mode. The B position is located at the lower end of the gate 3c, as viewed in FIG. 1.

Referring to FIG. 2, a tactile force application mechanism 4 is arranged between the shift lever 2 and a support (not shown) of the shift lever 2. The tactile force application mechanism 4 applies tactile force to the shift lever 2 when the shift lever 2 is moved. The tactile force application mechanism 4 also detects the tactile force. In this manner, the tactile force application mechanism 4 is provided with a tactile force application function (tactile force application unit) and a tactile force detection function (tactile force detection unit).

As shown in FIG. 2, the tactile force application mechanism 4 includes a piston 5 and a tactile plate 6. The piston 5 includes a tube 7, which serves as a housing. A bore 8 extends into the tube 7 from one end of the tube 7. The bore 8 accommodates a rod-shaped pin 9, which is movable back and forth in the longitudinal direction (direction indicated by arrow A in FIG. 2) of the tube 7. The pin 9 includes a round distal end that is in contact with the tactile plate 6. The pin 9 is formed from a material having high conductance such as iron. A spring 10 is accommodated in the bore 8 of the tube 7 to urge the pin 9 toward the tactile plate 6. The pin 9 is one example of a tactile force detection unit. The spring 10 is one example of an urging member. Further, in the present example, the piston 5 (pin 9 and spring 10) and the tactile plate 6 form a tactile force application unit that functions to apply tactile force.

To simplify the structure of the tactile force application mechanism 4 in the present example, the piston 5 is arranged on a fixed member of the shift lever device 1 (i.e., support of the shift lever 2), and the tactile plate 6 is arranged on a movable member of the shift lever device 1 (i.e., shift lever 2). Thus, when the shift lever 2 is operated and moved, the tactile plate 6 moves relative to the piston 5 along an arcuate path in cooperation with the shift lever 2.

As shown in FIG. 2, the tactile plate 6 includes ridges and valleys. In the present example, the tactile plate 6 includes slopes 11, which are continuous surfaces having difference inclination angles (gradients). FIG. 2 shows a portion of the tactile plate 6 along which the pin 9 moves when the shift lever 2 is moved between the N and D positions or between the N and R positions. The tactile plate 6 includes a tactile groove 12, which serves as the deepest valley and which is arranged at a location corresponding to the N position of the shift lever 2. The slopes 11 include, for example, slopes 11a to 11f. The slopes 11a and 11d form the tactile groove 12 and have a first gradient. The slopes 11b and 11e are respectively arranged next to the slopes 11a and 11d and have a second gradient, which is smaller than the first gradient. The slopes 11c and 11f are respectively arranged next to the slopes 11b and 11e and have a third gradient, which is larger than the second gradient. In the present example, the slopes 11a and 11d are formed so that the height from the bottom to the peak of the tactile groove 12 is greater at the slope 11a than the slope 11d.

When the shift lever 2 is operated, the pin 9, which is urged by the spring 10, moves along the slopes 11. This produces a load that acts on the shift lever 2 and is perceived as a tactile force by the driver. When a slope 11 is steep and has a high gradient, a large tactile force is applied to the shift lever 2. When a slope 11 is gradual and has a low gradient, a small tactile force is applied to the shift lever 2. Further, when the pin 9 moves from a steep slope 11 (in the present example, slopes 11a, 11d, 11c, and 11f) to a gradual slope 11 (in the present example, slopes 11b and lie), a tactile force peak or tactile force switching point is produced. This clicks the shift lever 2. The click may be transmitted to and recognized by the driver.

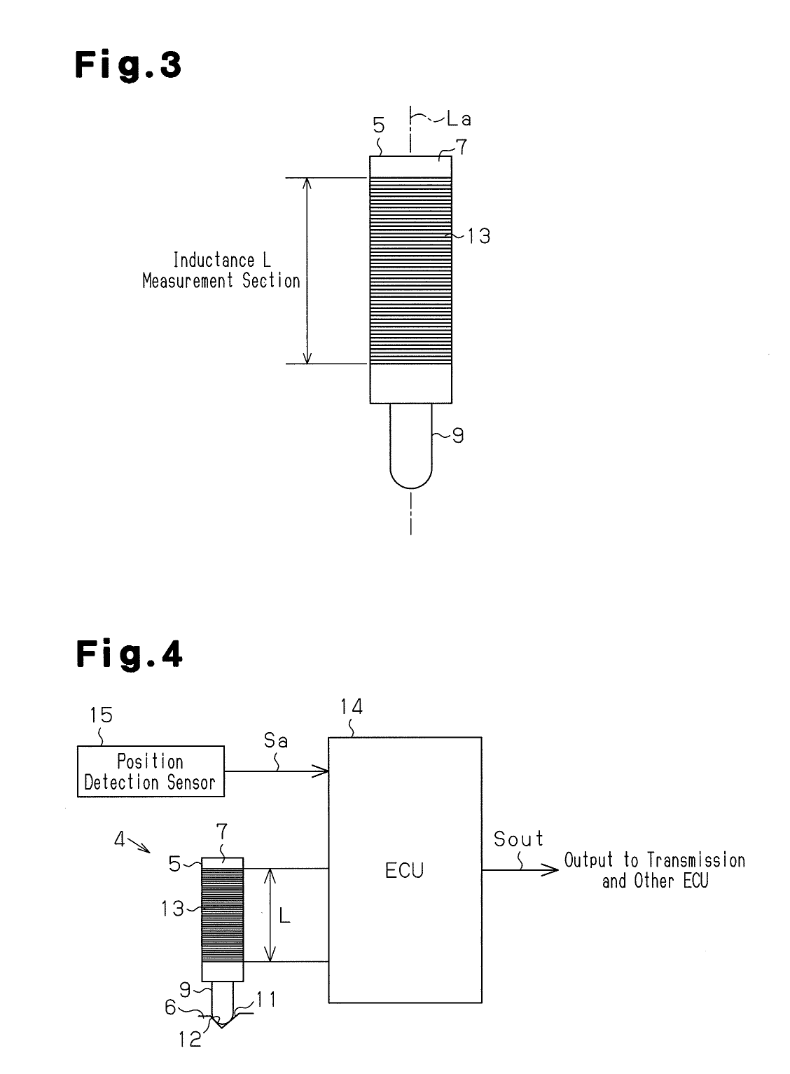

Referring to FIG. 3, a conductive wire is wound a number of times around the outer surface of the tube 7 to form a tubular coil 13. Accordingly, the coil 13 includes a hollow, and the pin 9, which has a high conductance, is arranged in the hollow to move back and forth along the axis La of the coil 13. Movement of the pin 9 in the coil 13 changes the inductance L of the coil. The inductance L of the coil 13 is measured to detect the tactile force applied to the shift lever 2. In this manner, the tactile force detection function (tactile force detection unit) of the present example is realized as a coil inductance sensor. In the present example, the pin 9 and the coil 13 form a tactile force detection unit. In this case, the inductance L of the coil 13 is one example of a tactile force detection signal.

Referring to FIG. 4, the shift lever device 1 includes an electronic control unit (ECU) 14 that controls the position detection of the shift lever device 1. The ECU 14 is connected to a position detection sensor 15, which detects the movement amount and movement direction of the shift lever 2. The position detection sensor 15 may be, for example, a rotary encoder. The position detection sensor 15 of the present example allows for detection of movement of the shift lever 2 in the shift direction (gate 3b or 3c) and the selection direction (gate 3a). The position detection sensor 15 detects the movement amount and the movement direction of the shift lever 2, and provides the ECU 14 with a detection signal Sa (e.g., pulse signal) corresponding to the detection. The ECU 14 determines the movement amount and the movement direction of the shift lever 2 from the detection signal Sa of the position detection sensor 15. The ECU 14 is one example of the position determination unit, and the position detection sensor 15 is one example of a movement detection unit. The detection signal Sa is one example of a movement detection signal.

The ECU 14 is connected to the coil 13, which is arranged around the tube 7. The ECU 14 applies a fixed voltage between the terminals of the coil 13, and detects changes in the applied voltage to calculate the inductance L of the coil 13. Based on the calculation of the inductance L, the ECU 14 recognizes the projection amount of the pin 9, that is, the tactile force applied to the shift lever 2 by the piston 5.

The ECU 14 determines the position of the shift lever 2 from the detection signal Sa of the position detection sensor 15 and the inductance L of the coil 13 to generate a position shift signal Sout. The ECU 14 provides the position shift signal Sout to the transmission and other ECUs. In the present example, the ECU 14 detects the peak of the tactile force applied to the shift lever 2 from the inductance L of the coil 13, and determines that the position of the shift lever 2 has been shifted when the tactile force peak is detected. The position shift signal Sout is one example of a position notification.

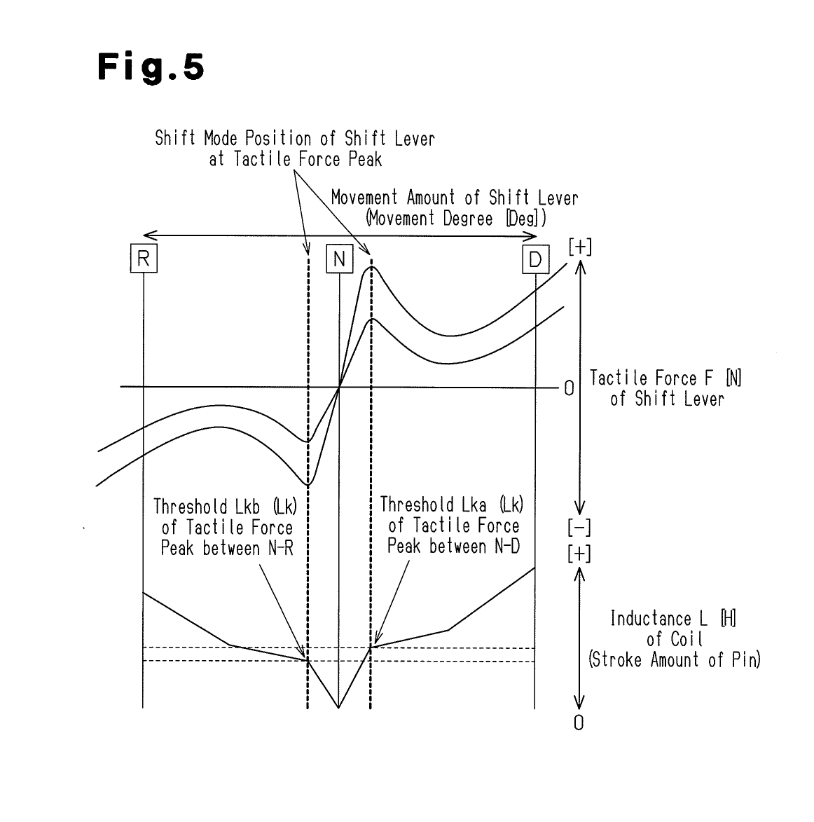

The operation of the shift lever device 1 will now be described with reference to FIG. 5.

FIG. 5 shows changes in the tactile force F [N] and the inductance L [H] relative to the movement amount (movement angle [Deg]) of the shift lever 2. The graph of the tactile force F in FIG. 5 shows the tactile force produced when the shift lever 2 is moved from the N position to the D position with a positive value, and the tactile force produced when the shift lever 2 is moved from the N position to the R position with a negative value. That is, the tactile force is indicated by a positive value when the shift lever 2 is moved between the N and D positions, and indicated by a negative value when the shift lever 2 is moved between the N and R positions.

In the present example, the tactile force F (shown by solid lines) produced when the shift lever 2 is moved from the N position to the D position or the R position differs from the tactile force F (shown by broken lines) produced when the shift lever 2 returns from the D position or the R position to the N position. This is because the pin 9 ascends along a slope 11 when the shift lever 2 moves to the D position or the R position, whereas the pin 9 descends along a slope 11 when the shift lever 2 returns from the D position or the R position to the N position. Therefore, the tactile force F produced when the shift lever 2 is moved from the N position to the D position or the R position is relatively large, whereas the tactile force F produced when the shift lever 2 returns from the D position or the R position to the N position is relatively small.

If the shift lever device 1 is of a momentary type, the pin 9 is most projected from the tube 7 at the stationary position of the shift lever 2, namely, the N position, and the pin 9 is most retracted into the tube 7 when moved by the maximum amount. Thus, when the shift lever 2 moves from the N position to the D position or the R position, the inductance L changes from zero to the maximum value. Accordingly, in a momentary type structure, the threshold Lk used to detect the tactile force peak between the N and D positions or between the N and R positions is set to a predetermined inductance value between zero and the maximum value. In the present example, the inductance value when the inductance L changes from a steep inclination to a gradual inclination is set as the threshold Lk. The position of the shift lever 2 is determined based on the detection of the inductance L corresponding to the threshold Lk, that is, the detection of the tactile force peak. In the present embodiment, the inductance value when the pin 9 shifts from the slope 11a to the slope 11b as the shift lever 2 moves to the D position is set as a first threshold Lka. Further, the inductance value when the pin 9 shifts from the slope 11d to the slope 11e as the shift lever 2 moves to the R position is set as a second threshold Lkb. Here, the threshold for detecting a tactile force peak between the N and D positions and the threshold for detecting a tactile force peak between the N and R positions are set as different values. The first and second thresholds Lka and Lkb correspond to the shapes of the slopes 11a and 11d, respectively. In the present example, the slope 11a extends to a higher position than the slope lid (refer to FIG. 2). Thus, the first threshold Lka is larger than the second threshold Lkb.

A case in which the shift lever 2 is moved from the N position to the D position will now be described. In this case, the pin 9 moves from the N position along the steep slope 11a. Thus, a large tactile force is produced when the shift lever 2 is moved. This requires a certain amount of force to move the shift lever 2 to the D position. Further, the gradual slope 11b follows the steep slope 11a. Thus, a click is produced when the pin 9 moves from the slope 11a to the slope lib, thereby allowing the driver to perceive that the shift lever 2 has been moved from the N position to the D position.

Based on the detection signal Sa of the position detection sensor 15, the ECU 14 determines whether or not the shift lever 2 is moving in the shift direction (gate 3b) from the N position to the D position or from the N position to the R position. Further, based on the detection signal Sa of the position detection sensor 15, the ECU 14 determines whether or not the shift lever 2 is moving in the selection direction (gate 3a) from the N position to the home position. This allows the ECU 14 to recognize movement of the ECU 14 from the N position to the D position.

When the shift lever 2 is moved from the N position to the D position, the ECU 14 sets the detection threshold of the tactile force peak as the first threshold Lka, and compares the actual inductance L with the first threshold Lka. When the inductance L is greater than or equal to the first threshold Lka, the ECU 14 determines that the shift lever 2 has been shifted to the D position and sends a D position shift signal to the transmission as the position shift signal Sout. Thus, as the driver moves the shift lever 2 to the D position, the ECU 14 shifts the transmission to the drive mode when the tactile force peak (first threshold Lka) is detected.

Next, a case in which the shift lever 2 is moved from the N position to the R position will be described. In this case, a click perceived by the driver is produced when the pin 9 moves from the slope lid to the gradual slope lie. The ECU 14 detects the movement of the shift lever 2 from the N position to the R position with the position detection sensor 15, and sets the detection threshold of the tactile force peak as the second threshold Lkb. When the inductance L is greater than or equal to the second threshold Lkb, the ECU 14 determines that the shift lever 2 has been shifted to the R position and sends an R position shift signal to the transmission as the position shift signal Sout. Thus, as the driver moves the shift lever 2 to the R position, the ECU 14 shifts the transmission to the reverse mode when the tactile force peak (second threshold Lkb) is detected.

Examples of the control performed to determine the shift lever position when the shift lever 2 is moved from the N position to the D position or the R position have been described above. Although the shift lever 2 is operated in different directions when moving the shift lever 2 from the home position to the N position or the B position, the position determination control is performed in the same manner.

The present embodiment has the advantages described below.

(1) The shift lever device 1 includes the tactile force application mechanism 4 that applies tactile force to the shift lever 2 and functions to detect the tactile force. Further, the shift lever device 1 recognizes the tactile force applied to the shift lever 2 by measuring the inductance L of the coil 13. The shift lever device 1 determines the position of the shift lever 2 from the value of the measured inductance L. The shift lever device 1 also determines whether or not the shift lever 2 has shifted positions based on the value of the measured inductance L and shifts the modes of the transmission. This structure allows the driver to easily perceive that the shift lever 2 has shifted positions.

(2) The shift lever device 1 determines the position of the shift lever 2 by detecting the movement amount and the movement direction of the shift lever 2 with the position detection sensor 15 and obtaining the tactile force applied to the shift lever 2 based on the inductance L of the coil 13 and the detection signal Sa of the position detection sensor 15, which indicates the movement amount and the movement direction of the shift lever 2. In this manner, the position of the shift lever 2 is determined taking into consideration the movement amount and the movement direction of the shift lever 2. This allows for the position of the shift lever 2 to be accurately determined.

(3) When the shift lever 2 is moved and a tactile force peak is produced, the shift lever device 1 determines that the position of the shift lever 2 has been shifted. This allows for the transmission to shift modes when the movement of the shift lever 2 produces a click. Thus, the driver may be provided with a strong tactile feel of the shift lever 2.

(4) A conductive component is used as the pin 9, which serves as a tactile force application unit, and the inductance L of the coil 13 arranged around the pin 9 is measured to detect the tactile force. In this manner, the tactile force detection unit uses a component of the tactile force application unit. Since components may be shared, the number of components may be kept low even when adding the tactile force detection function to the shift lever device 1.

It should be apparent to those skilled in the art that the present invention may be embodied in many other specific forms without departing from the spirit or scope of the invention. Particularly, it should be understood that the present invention may be embodied in the following forms.

The shift lever 2 may be of a stationary type in which the shift lever 2 remains at each mode position. In a stationary type structure, the pin 9 is most projected at each mode position and most retracted between mode positions. In this case, the detection threshold of the tactile force peak is set to the value of the inductance L when the pin 9 is most retracted.

The shift lever 2 is determined as being located at the N position when the value of the measured inductance L is less than the threshold Lk, and determined as being located at the D position or R position when the value of the measured inductance L is greater than or equal to the threshold Lk. However, the position of the shift lever 2 does not have to be determined based on whether or not the value of the measured inductance L is greater than or equal to a threshold. For instance, position determination ranges of the inductance L may be set in advance. As one example, the shift lever 2 may be determined as being located at the N position when the value of the measured inductance L is in a first range (e.g., lower range), and the shift lever 2 may be determined as being located at the D or R position when the value of the measured inductance L is in a second range (e.g., higher range), and

The tactile force peak does not have to be detected based on whether or not the value of the measured inductance L is simply greater than or equal to the threshold Lk. For example, the shift lever device 1 may successively monitor changes in the inductance L per unit time, and determine that a tactile force peak has been produced when the amount of change becomes less than a threshold.

The threshold Lk does not have to be a fixed value and may be a variable value.

The first and second thresholds Lka and Lkb may be the same value.

The tactile plate 6 may be shaped in accordance with the necessary tactile force. The threshold Lk is set based on the shape of the tactile plate 6.

A shift pattern does not have to have the reverse h-shape shown in FIG. 1. Any of various types of shift patterns may be employed. For example, a straight shift pattern or a type in which a sequential operation function is added to a straight shift pattern may be employed. As another example, a shift pattern with gates for multiple gears may be employed.

The tactile force application unit (tactile force application function) does not have to be formed by the pin 9, the tactile plate 6, and the spring 10. Any structure may be employed as the tactile force application unit as long as tactile force can be applied to the shift lever 2.

The tactile force application mechanism 4 may be formed by arranging the piston 5 on a movable member, and the tactile plate 6 may be arranged on a fixed member.

The shift lever 2 may be of a sliding type.

The mode positions of the shift lever 2 may include other positions, such as a parking (P) position, a first gear position that shifts the transmission to a first gear, and a second gear position that shifts the transmission to a second gear.

The position detection sensor 15 (movement detection unit) may be replaced by a different sensor such as a stroke sensor. Further, the movement detection unit need only detect at least one of the movement amount and the movement direction of the shift lever 2 (operation member).

The position detection unit is not limited to a contactless sensor and may be a contact switch such as a microswitch.

The tactile force detection unit (tactile force detection function) may be a structure using a piezoelectric element.

The tactile force detection unit (tactile force detection function) may be formed by a gear and a sensor that detects rotation of the gear.

The tactile force detection unit (tactile force detection function) may be a structure using a magnetic sensor (e.g., a set of a Hall IC and a magnet).

The tactile force detection unit (tactile force detection function) may be a structure using a contact switch.

The stroke amount (tactile force) of the pin 9 may be detected by, for example, providing high frequency to the coil 13 and checking the amplitude. Alternatively, the changes in the resonant frequency of a coil and a capacitor may be checked.

The vehicle may be a gasoline vehicle, a plug-in hybrid vehicle, an electric vehicle, a fuel vehicle, and the like.

The operation device is not limited to a lever operation type and may be of a different type, such as a dial operation type.

The position of the shift lever 2 may be determined by using only the tactile force detection signal (e.g., value of the measured inductance L).

The operation device may be realized in a device other than the shift lever device 1 such as a lever combination switch device. That is, the operation device is not limited to a transmission and may be applied to other in-vehicle devices. Further, the application of the operation device is not limited to an in-vehicle device. The operation device may be applied to apparatuses and systems other than a vehicle.

The present examples and embodiments are to be considered as illustrative and not restrictive, and the invention is not to be limited to the details given herein, but may be modified within the scope and equivalence of the appended claims.

1. An operation device that controls an apparatus, the operation device comprising:
an operation member that is movable to a plurality of positions, wherein the operation device sends an electric signal to the apparatus in accordance with the position of the operation member;
a tactile force application mechanism that applies tactile force to the operation member when the operation member is moved, wherein the tactile force application mechanism includes a tactile force detection unit that detects the tactile force applied to the operation member and outputs a tactile force detection signal; and
a position determination unit that determines the position of the operation member based on the tactile force detection signal.

2. The operation device according to claim 1, further comprising a movement detection unit that detects at least one of a movement amount and a movement direction of the operation member and outputs a movement detection signal, wherein the position determination unit determines the position of the operation member based on the tactile force detection signal and the movement detection signal.

3. The operation device according to claim 1, wherein the position determination unit determines that the operation member has been moved to a target position when detecting a tactile force peak of the operation member from the tactile force detection signal.

4. The operation device according to claim 1, wherein
the tactile force application mechanism includes
a tactile plate,
a pin facing the tactile plate, and
an urging member that urges the pin toward the tactile plate, wherein when the pin moves along the tactile plate against an urging force of the urging member, load acting on the pin is applied as the tactile force to the operation member; and
the tactile force detection unit includes
a coil formed by winding a conductive wire, and
the pin that is conductive and movable back and forth in the coil; and
the position determination unit determines the position of the operation member from inductance of the coil that changes in accordance with where the pin is located.

5. The operation device according to claim 4, wherein the tactile plate includes a plurality of slopes that are continuous surfaces having difference gradients, the plurality of slopes including
two first slopes that form a tactile groove and each have a first gradient,
two second slopes that are respectively arranged next to the two first slopes and each have a second gradient, which is smaller than the first gradient, and
two third slopes that are respectively arranged next to the two second slopes and each have a third gradient, which is larger than the second gradient.

6. The operation device according to claim 1, wherein
the operation device is a shift lever device, and
the apparatus is a transmission.
